(19) United States
(12) Patent Application Publication
(10) Pub. No.: US 2009/0016728 A1
(43) Pub. Date: Jan. 15, 2009

(54) Method and system for pairing a remote control with a device

(75) Inventor: Brian Kindle, Sunnyvale, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: Marquee, Inc.

(21) Appl. No.: 11/670,152

(22) Filed: Feb. 1, 2007

(51) Int. Cl. H04B 10/00

(52) U.S. Cl. 398/106

(57) ABSTRACT

Techniques for pairing a remote control to a device are disclosed. After a specific button is pressed or buttons are pressed in a specific order, a remote control is caused to enter a re-programming mode. In the mode, the transmitting power of the remote control is significantly reduced, resulting in a much smaller working range. In addition, an identifier in the remote control is changed so that all subsequent command signals from the remote carry a different identifier. For the device to respond to the change in the remote control, a user has to bring the remote control up close to the device for receiving a command signal carrying the changed identifier from the remote control. Once the remote control is back to a normal mode, the remote control is paired with the device within its own working range.

### BACKGROUND

1. Technical Field

The present invention relates generally to the area of electronic devices, and more particularly to method and system for pairing a remote control with a device.

2. Description of the Related Art

A remote control is an electronic device used for the remote operation of a machine. The term, sometimes abbreviated to “remote” and also called a “controller”, “flipper”, “clicker”, or “changer”, is most commonly used to refer to a remote control for televisions or other consumer electronics such as stereo systems and DVD players. Remote controls for these devices are usually small wireless handheld objects with an array of buttons for adjusting various settings such as television channel and volume. In fact, for the majority of modern devices with this kind of control, the remote contains all the function controls while the controlled device itself only has a handful of essential primary controls. Most of these remote controls communicate to their respective devices via infrared (IR) signals. However, remote controls require line-of-sight communication, namely a user has to point a remote control to a device. In spite to the inconvenience that requires such an aiming, an IR remote control sometime causes other remote-controlled devices that are stacked together to do something that is not intended.

There is a second type of remote controls that operate on radio signals. Radio control is the use of radio signals to remotely control another device. Accordingly, such a remote control includes a transmitter, and a device to be controlled includes a receiver. A major advantgae of the radio-based remote control is the removal of the requirement of line-of-sight communication. In other words, as long as it is within a working range, the remote control's ability to control the device is maximized and the susceptibility thereof to interference from obstacles to line-of-sight is minimized. This advantage, nevertheless, exposes a problem of the radio-based remote control because such a remote control may operate on other devices that are also controlled by radio.

There is a need for solutions that can distinguish remote controllers so that a radio-based remote control can only be paired with intended device(s).

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to a mechanism for pairing a remote control to a device. According to one aspect of the present invention, after a specific button is pressed or buttons are pressed in a specific order, a remote control is caused to enter a re-programming mode. In the mode, the transmitting power of the remote control is significantly reduced, resulting in a much smaller working range. In addition, an identifier in the remote control is changed so that all subsequent command signals from the remote carry a different identifier. For the device to respond to the change in the remote control, a user has to bring the remote control up close to the device for receiving a command signal carrying the changed identifier from the remote control. Once the remote control is back to a normal mode, the remote control is paired with the device within its own working range, command signals from the remote control can only be recognized by the device, or the device ignores all but the command signals carrying the identifier.

An interface detection circuit is provided to detect whether the specific button is activated or a specific sequence of buttons has been pressed. If it happens, the interface detection circuit causes a different identifier to replace an original identifier and meanwhile the transmitting power of a transmitter module in the remote control to be significantly reduced. Depending on the modulation method in the radio frequency (RF) signal used by the remote control, the identifier may be one or more parameters to alter pulses/waves or a flag (e.g., an address) in a bit stream in the command signals.

The present invention can be advantageously used in entertainment systems closely suited, in which cases remote controls share an identical identifier are likely in respective working ranges. To avoid interference among the systems, the present invention may be used to pair a particular remote control to a particular system so that command signals from other remote controls may be ignored.

The present invention may be implemented as a method, an apparatus or part of a system. According to one embodiment, the present invention is a method for pairing a remote control to a device. The method comprises: activating the remote control to a re-programming mode; changing an original identifier to a different identifier in the remote control so that all command signals from the remote control carry the different identifier; and reducing significantly transmitting power of the remote control, which causes a user to bring the remote control up close to the device to receive a special command carrying the different identifier from the remote control, wherein the device subsequently responds only to command signals carrying the different identifier.

According to another embodiment, the present invention is a system for pairing a remote control to a device. the system comprises: a device to be controlled by a remote control, the remote control including: a sequence detector that causes transmitting power of the remote control to be reduced significantly when the sequence detector detects more than one of buttons on the remote control have been pressed in a specified order; and an identifier generator, configured to be activated by the sequence detector, changing an original identifier to a different identifier in the remote control so that all command signals from the remote control carry the different identifier. As a result of the reduced transmitting power, the remote control has to be brought up close to the device to receive a special command carrying the different identifier from the remote control, wherein the device subsequently responds only to command signals carrying the different identifier.

Many other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 a system involving a remote control and a device to be controlled by the remote control; and

FIG. 2 shows a stitution in which two respective systems are located sufficiently close enough.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

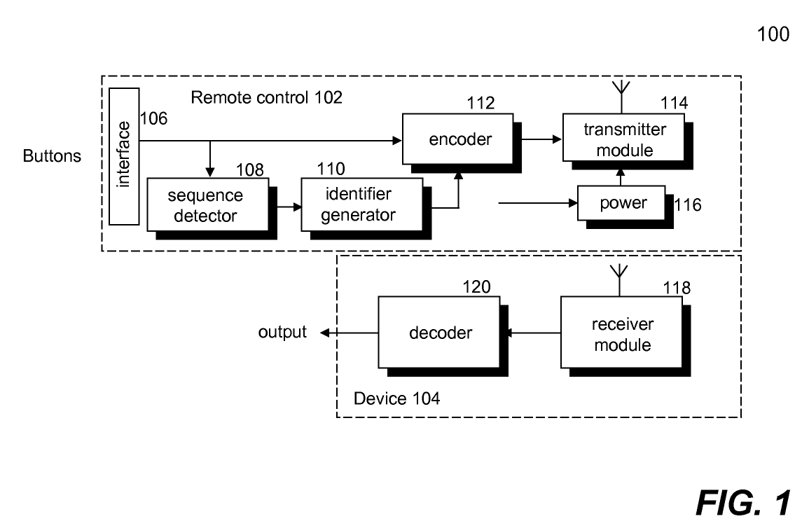

Referring now to the drawings, in which like numerals refer to like parts throughout the several views. FIG. 1 shows a system 100 involving a remote control 102 and a device 104 to be controlled by the remote control 102. The remote control 102 is shown as a functional block diagram according to one embodiment of the present invention. One of the features, objects, and advantages provided by the remote control 102 is an embedded mechanism that can be activated by a user to make the remote control 102 unique to the device 104 within a predefined working range. It is known to those skilled in the art that there are many remote controls in use. It is not likely or practically unnecessary to have a remote control only unique to one device. Therefore the uniqueness herein is defined within a working range, namely, other remote controls in a working range of a subject remote control will be ignored by a device to be controlled only by the subject remote control.

In one embodiment, the remote control 102 includes an interface 106, a sequence detector 108, an identifier generator 110, an encoder 112, a power control 114 and a transmitter module 116. Depending on implementation, the interface 106 includes a set of buttons, keys (e.g., displayed on a touch screen) or rolling wheels. Unless otherwise specified, buttons are generally used herein to indicate any types of interaction between a user and a remote control by all means.

When the user interacts with buttons on a remote control, signals corresponding to the activation of the buttons generated by the interface 106 are coupled to the encoder 112 that encodes the signals to a representation. Depending on the modulation method used, the representation may be a digital bit stream or a sequence of pulses/waves. The representation is then transmitted by the transmitter module 116 (e.g., after modulated). For example, a user desires to turn on a television set. A specially designated button is then pressed. The interface 106 generates a signal that is encoded to a command signal. The command signal is transmitted by the transmitter module 116 via an antenna. On the television side (e.g., the device 104), a corresponding receiver module 118 receives the command signal that is then decoded by a decoder 120. The output of the decoder 120 gives the command to a power switch in the television, the power switch acts to turn on the television.

What is different from the prior art remote control devices is an embedded mechanism in the present invention, where the embedded mechanism can be activated to cause the command signal unique to a device. As shown in FIG. 1, in addition, the remote control 102 further shows there are a sequence detector 108 and an identifier generator 110. According to one aspect of the present invention, a specific button or buttons in a specific order will activate the sequence detector 108 that cause the activation of the identifier generator 110. The identifier generator 110 changes from an original identifier set by default to a different one so that no two remote controllers in an operating range share the same identifier. As a result of the change of the identifier, the encoder 112 produces all subsequent command signals in accordance with the new identifier.

For example, a button in a pinhole or three buttons: a volume button and a “1” button followed by a power-on button may be defined to cause the remote control 102 to re-program itself. When a user notices that there may be more than one remote control in the area that may effect the operation of his device, he can press the special button or these three buttons in a sequence. The signals from the interface 106 are intercepted by the sequence detector 108. The identifier generator 110 is then activated to change the default identifier to a different identifier. To reduce the interference of this re-programming process, in one embodiment, the power 114 that energizes the transmitter module 116 is significantly reduced so that the transmitting range thereof is reduced. There are many ways to control the power 114 or the transmitting power of the transmitter module 116. For example, the output of the sequence detector 108 may be used for the control, or the control takes place whenever the identifier generator 110 operates. As a result, the user has to bring the remote control up close to the device for the device to respond to the re-programming process of the remote control.

According to one embodiment, pulse width modulation (PWM) or pulse position modulation (PPM) is used for transmitting the command signals to the receiver 104. In PWM, the width (duration) of the pulse for a channel is between 920 μs and 2120 μs with 1520 μs being the center (neutral) position. The pulses are repeated in a frame of between 10 and 30 milliseconds in length. Accordingly, in the type of remote controls that use PWM, the identifier 110 generates one or more parameters that cause the the encoder 112 to produce pulses differently from the default but still within the specification. Once the device reponds to the changes, signals from other remote controls would be ignored by the device.

According to another embodiment, instead of the analog type pulse modulation, a digital modulation scheme (e.g., PSK, FSK and ASK) is used to convey data by changing, or modulating, the phase, frequency or amplitude of a reference signal (i.e., carrier wave). The digital modulation scheme uses a finite number of distinct signals to represent a command representation. In one type of such remote controls, there are 32 available addresses, all remote controllers are defaulted to one of these addresses, hopefully through the commercial distribution, no neighboring households would have the same remote controls with the same addresses.

With the present invention, even if neighboring households happen to have the same remote controls with the same addresses, a user may re-program his remote control so that his remote control would be different from others in address. Accordingly, when a predefined sequence of buttons has been pressed, the identifier generator 110 generates an increment (e.g., one, two or any integer) that changes from the default address to another one of the available addresses. Once the device reponds to the changes, signals from other remote controls would be ignored by the device

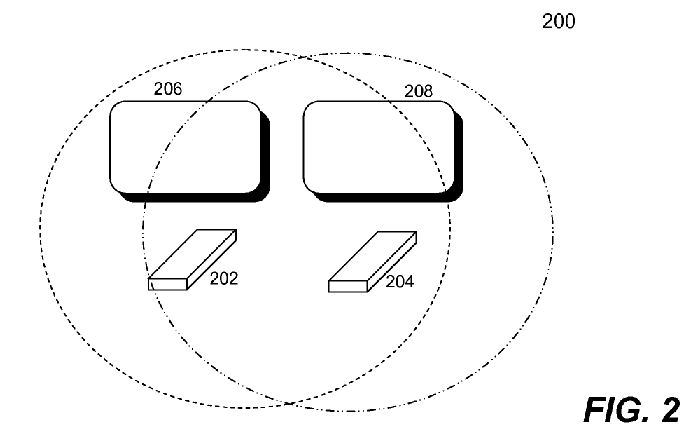

FIG. 2 shows a stitution 200 in which two respective systems are located sufficiently close enough. As a result, a working range for one remote control 202 overlaps with a working range for another remote control 204. If these two remote controls 202 and 204 based on PSK digital modulation happen to share an identical address, an operation on the remote control 202 would affect a device 208 that is supposed to be controlled by the remote control 204. Likewise, an operation on the remote control 204 would affect a device 206 that is supposed to be controlled by the remote control 202.

By implementing one embodiment of the present invention, a user of the remote control 202 may press a sequence of buttons on the remote control 202. As a result of these buttons being sequentially pressed, the working range of the remote control 202 is immediately reduced due to the reduced transmitting power. The user has to bring the remote control 202 close to the device 206. The remote control 202 sends a command signal (e.g., a type of command representation) that includes a change of the address from the default to a different address (e.g., 0011-0100). In responding to the command signal, the device 206 records the changed address. Subsequently, all signals from the remote control 204 would be ignored because these signals carring the default address could no longer be recognized. The device 206 will only respond to command signals carrying the changed address.

One of the advantages, benefits and objects in the present invention is to alleviate a manufacturer of remote controls from a process of segregating newly manufactured remote controls to ensure they are statistically different in an area.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A method for pairing a remote control to a device, the method comprising:
activating the remote control to a re-programming mode;
changing an original identifier to a different identifier in the remote control so that all command signals from the remote control carry the different identifier; and
reducing significantly transmitting power of the remote control, which causes a user to bring the remote control up close to the device to receive a special command carrying the different identifier from the remote control, wherein the device subsequently responds only to command signals carrying the different identifier.

2. The method as recited in claim 1, wherein said activating the remote control to a re-programming mode comprises activating a specific sequence of buttons on the remote control.

3. The method as recited in claim 2, wherein there is a set of identifiers for the remote controls in accordance with a modulation standard, said changing an identifier to a different identifier in the remote control comprises rotating among the identifiers from the original identifier to the different identifier.

4. The method as recited in claim 3, wherein the modulation standard is analog, the identifier includes one or more parameters to control characteristics of signals to be transmitted by a transmitted module in the remote control.

5. The method as recited in claim 3, wherein the modulation standard is digital, the identifier includes an address to be embedded in a data stream to be transmitted by a transmitted module in the remote control.

6. The method as recited in claim 3, wherein the modulation standard is based on any one of Phase-shift keying (PSK), Frequency-shift keying (FSK), or Amplitutde-shift keying (ASK), and there are N available addresses, the original identifier is one of the N addresses and the different identifier is another one of the N addresses, where N is a finite integer.

7. The method as recited in claim 1, wherein the remote control includes a sequence detector that causes the transmitting power to be reduced when the sequence detector detects more than one of the buttons on the remote control have been pressed in a specified order.

8. A system for pairing a remote control to a device, the system comprising:
the device to be controlled by the remote control;
the remote control including:
a sequence detector that causes transmitting power of the remote control to be reduced significantly when the sequence detector detects more than one of buttons on the remote control have been pressed in a specified order;
an identifier generator, configured to be activated by the sequence detector, changing an original identifier to a different identifier in the remote control so that all command signals from the remote control carry the different identifier; and
wherein, as a result of the reduced transmitting power, the remote control has to be brought up close to the device to receive a special command carrying the different identifier from the remote control, wherein the device subsequently responds only to command signals carrying the different identifier.

9. The system as recited in claim 8, wherein there is a set of identifiers for the remote controls in accordance with a modulation standard, said changing an identifier to a different identifier in the remote control comprises rotating among the identifiers from the original identifier to the different identifier.

10. The system as recited in claim 9, wherein the modulation standard is analog, the identifier includes one or more parameters to control characteristics of signals to be transmitted by a transmitted module in the remote control.

11. The system as recited in claim 9, wherein the modulation standard is digital, the identifier includes an address to be embedded in a data stream to be transmitted by a transmitted module in the remote control.

12. The system as recited in claim 9, wherein the modulation standard is based on Phase-shift keying (PSK), Frequency-shift keying (FSK), or Amplitutde-shift keying (ASK), and there are N available addresses, the original identifier is one of the N addresses and the different identifier is another one of the N addresses.
